(19) United States
(12) Patent Application Publication
(10) Pub. No.: US 2012/0240125 A1
(43) Pub. Date: Sep. 20, 2012

(54) System Resource Management In An Electronic Device

(75) Inventors: Attilla Danko, Nepean (CA); Brian John Stecher, Ottawa (CA)

(73) Assignee: QNX SOFTWARE SYSTEMS CO, Ottawa (CA)

(21) Appl. No.: 13/051,609

(22) Filed: Mar. 18, 2011

(51) Int. Cl. G06F 9/46

(52) U.S. Cl. 718/104

(57) ABSTRACT

A system and method of managing resources of an electronic device are described. A solver of the electronic device may receive one or more resource requirements from one or more resource requesters executing on the electronic device. The solver determines a values for resource characteristic based on the received resource requirements and dependency information defining hierarchical dependency between resource characteristic values associated with resources of the electronic device. The determined values of the resource characteristics are then provided to the associated resources of the electronic device.

### TECHNICAL FIELD

The following description relates to electronic devices, and in particular to managing resources of the electronic device in relation to performance and power management.

### BACKGROUND

Electronic devices are composed of a plurality of cooperating components. The individual components may have one or more operating characteristics that can be varied to change the performance or operation of the component as well as the overall electronic device. For example, a portable computing device may include a processor, a display screen and a network adapter. The processor may be operated using different clock frequencies and voltages, the brightness of the display screen may be adjusted higher or lower, and the latency of the network adapter may be increased or decreased. Adjusting operating characteristics of the individual components has associated tradeoffs, typically the higher the performance the greater the energy consumption, which may be undesirable for portable devices.

The components of electronic devices have become more complex and intelligent. Individual components, or groups of components may self manage the operating characteristics of the components in order to reduce the total power consumption of the electronic device or meet other desired characteristics. For example, a processor may employ active power consumption management techniques including dynamic voltage and frequency scaling (DVFS), adaptive voltage scaling (AVS) and/or dynamic voltage switching (DVS), which change the operating characteristics of the processor.

While components that may self manage their power consumption can improve the overall power consumption of the electronic device, there is little ability for the overall electronic device to manage the performance of components that have their operating characteristics managed by other components, including self-managed components as well as more traditional components, in order to meet performance or other requirements in a power efficient manner.

Further complicating power consumption and performance management is the fact that different electronic devices have different specific hardware components and as such different operating characteristics, making it difficult or time consuming to provide advanced power management since knowledge of the actual components is necessary in order to optimize the performance and power consumption of electronic devices. Therefore there is a need for an improved system and method of managing resources in an electronic device.

### BRIEF DESCRIPTION OF THE DRAWINGS

Embodiments are described herein with reference to the appended drawings, in which:

FIG. 1 depicts in a block diagram components of an electronic device in which a policy manager as described further herein may be used;

FIG. 2 depicts in a block diagram components of an electronic device that can manage the performance of components of the electronic device;

FIG. 3 depicts in a block diagram components of a policy manager;

FIG. 4 depicts in a block diagram components of a further policy manager;

FIG. 5 depicts in a flow chart a method of managing resources on an electronic device;

FIG. 6 depicts in a flow chart a further method of managing resources on an electronic device;

FIG. 7 depicts an illustrative dependency requirement for a browser;

FIG. 8 depicts an illustrative dependency requirement for an audio player;

FIG. 9 depicts an illustrative dependency requirement for a game;

FIG. 10 depicts an illustrative dependency requirement for a screen blanking application;

FIG. 11A depicts illustrative authority information associated with the applications of FIGS. 6-10; and

FIG. 11B depicts illustrative partial authority information associated with the applications of FIGS. 6-10.

### DETAILED DESCRIPTION

In accordance with an aspect of the present disclosure there is provided a method of managing resources of an electronic device. The method comprising receiving resource requirements from one or more resource requesters on the electronic device. Determining values for a plurality of resource characteristics associated with resources of the electronic device based on the received resource requirements and dependency information defining hierarchical dependency requirements between defined resource characteristic values and providing the determined resource characteristic values for the plurality of resource characteristics to the respective associated resources of the electronic device.

In accordance with another aspect there is provided an electronic device for managing performance of resources of the electronic device. The electronic device comprising a processor for processing instructions; a storage unit for storing instructions and data, the instructions when executed by the processor configuring the electronic device to provide a policy manager. The policy manager comprising: an interface for receiving resource requirements from one or more resource requesters executing on the electronic device. A solver for determining values for a plurality of resource characteristics associated with resources of the electronic device based on the received resource requirements and dependency information defining hierarchical dependency requirements between defined resource characteristic values; and a resource interface for providing the determined resource characteristic values to the respective associated resources of the electronic device.

In accordance with yet another aspect there is provided a computer readable memory comprising instructions for execution by a processor. The instructions comprising receiving resource requirements from one or more resource requesters on the electronic device. Determining values for a plurality of resource characteristics associated with resources of the electronic device based on the received resource requirements and dependency information defining hierarchical dependency requirements between defined resource characteristic values; and providing the determined resource characteristic values for the plurality of resource characteristics to the respective associated resources of the electronic device.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

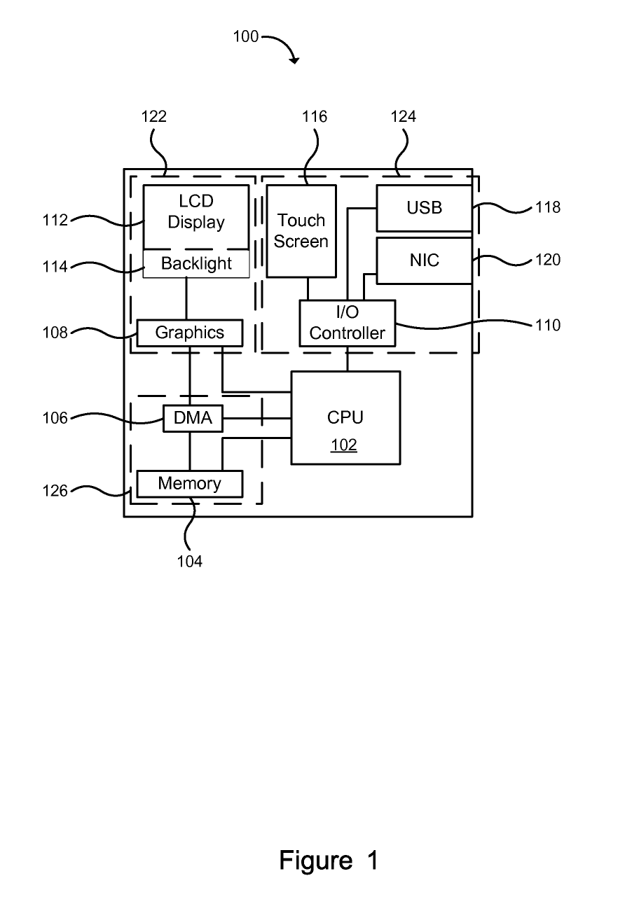

FIG. 1 depicts in a block diagram hardware components of an electronic device in which a policy manager as described further herein may be used. The electronic device 100 is considered herein as a portable electronic device such as a smart-phone or tablet device having a touch screen. It is also contemplated that the electronic device may be other types of electronic devices including, for example, laptop computers, personal computers, set-top boxes, personal entertainment devices, navigation devices, vehicle control systems, network devices or other electronic devices that may benefit from managing component performance.

The electronic devices 100 comprise various cooperating hardware components that must interact during the operation of the electronic device. A central processing unit (CPU) 102 executes instructions to control the overall operation of the electronic device 100. The CPU 102 may be connected directly or indirectly to a plurality of hardware components, including a storage unit 104 or computer readable memory, a direct memory access (DMA) controller 106, a graphics processor 108, and an input/output (I/O) controller 110. As depicted, other hardware components may be connected to CPU (102) through other components. For example, a display, which may comprise an LCD display 112 and associated backlight 114 may be connected to the CPU through the graphics processor 108. Similarly, a touch screen component 116, a universal serial bus (USB) port or controller 118, or local wired data connection interface, and a wired or wireless network interface component (NIC) 120 may be connected to the CPU 102 through one or more controllers, represented by I/O controller 110. Each of the hardware components may have one or more operating characteristics that can be adjusted in order to control the performance of the hardware component.

The hardware components and connections depicted in FIG. 1 are illustrative and not all required components are depicted. For example, a battery is not shown, however would be required for a portable device. Similarly, not all components depicted may be required based upon the particular electronic device.

In order to conserve power it may be possible to turn off, or otherwise change operating characteristics of, individual hardware components. For example, often the backlight of the display will be powered down or its brightness reduced if no user input has been received for a specified period of time, for example one minute. Power consumption may be further reduced by powering down groups of hardware components or sections of the electronic device 100. For example, three power domains are depicted by broken boxes 122, 124 and 126. If there are no graphics to be displayed the entire graphics power domain 122, which comprises the graphics controller 108, LCD display 112 and backlight 114, may be powered down or turned off. Similarly, if the I/O components are not required an I/O power domain 124 comprising the I/O controller 110, the touch screen 116, the USB 118 and the NIC 120, can be powered down. A memory power domain 126 is also depicted as comprising the DMA controller 106 and the memory 104. If there is no memory access it may be possible to power down the memory power domain 126.

Powering down hardware components and power domains can improve power consumption, however it requires specific knowledge of the hardware components implemented in the electronic device and the hardware components in the different power domain. Furthermore, when powering up a power domain and its hardware components, it may be desirable to power on the hardware components in a specific order. For example, it may be desirable to power on the graphics controller 108, followed by the LCD display 112 and finally the backlight 114.

In addition to powering down hardware components and power domains, power consumption may be reduced by reducing performance of the components by adjusting one or more operating characteristics. For example, the brightness of the backlight may be lowered to reduce the power consumed. As a further example, the graphics controller 108 may be able to provide both 2-dimensional (2D) and 3-dimensional (3D) processing modes. The 2D processing mode may consume less power, but does not provide the performance of the 3D mode which may be required for processing 3D data. By reducing the performance of hardware components, the power consumption of the electronic device is generally also reduced.

The operating characteristics of hardware components of the electronic device 100 may be controlled in various ways depending on the capabilities of the hardware components. For example, some hardware components may allow values for specific operating characteristics to be set by an external component. These hardware components may be referred to as externally-managed components, since the actual operating characteristics of the hardware component may be controlled by external components.

Hardware components of the electronic device 100 may be able to manage their own operating characteristics. Such devices may be referred to as self-managed components. Self-managed components can determine for themselves values for one or more operating characteristics. For example, the processor may be able to change one or more operating characteristics, such as the voltage or clock frequency, depending on the current processing requirements and operating conditions. Self-managed components may change the values of operating characteristics on a millisecond or nanosecond time scale, making it difficult for external control of the operating characteristics. It is possible to provide information to self-managed components that can be used when determining the values for the different operating characteristics. For example, the information may provide a desired level of response or performance, and the self-managed component can use this information, along with additional information available to it, in order to determine for itself the values for its operating characteristics.

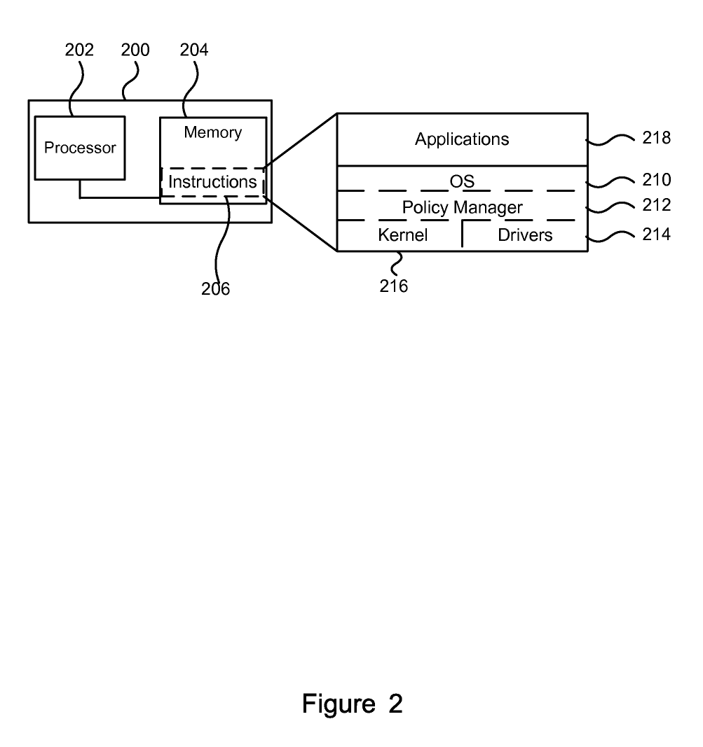

FIG. 2 depicts in a block diagram components of an electronic device 200 that can be used to manage resources of the electronic device. The resources managed may comprise both hardware and software components, including both externally-managed components and self-managed components, of the electronic device. It is noted that not all of the components of the electronic device 200 are depicted for simplicity. The electronic device 200 comprises a processor 202 for executing instructions and a memory 204 for storing instructions 206. The instructions 206, when executed by the processor 202, configure the electronic device 200 to provide various functionality. The functionality may include an operating system (OS) 210 and applications 218 that interact with the OS 210. The OS 210 may comprise a policy manager 212 that manages the resources of the electronic device 200. The OS 210 may also comprise a kernel 216 that comprises core functionality of the OS 210, such as a scheduler for scheduling the execution of processes or threads. The OS 210 may also comprise one or more drivers 214 which allow hardware components of the electronic device to operate with, and be controlled by software components such as, the OS 210, and applications 218. Although depicted as part of the OS 210, the policy manager 212 and the one or more drivers 214 may be implemented separately from the OS 210.

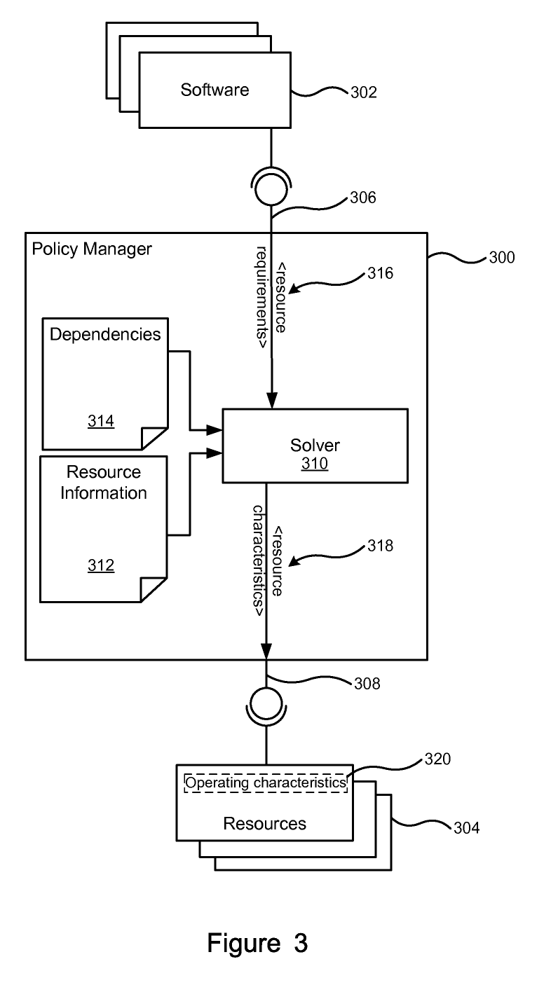

FIG. 3 depicts in a block diagram components of a policy manager. The policy manager 300 allows one or more software components 302 to provide resource requirements 316 during operation. Although described herein as software components 302 for clarity, the policy manager 300 may receive resource requirements 316 from various resource requesters that may include the software components 302 and/or other resources of the electronic device including hardware components capable of communicating with the policy manager 300. The policy manager 300 receives resource requirements 316 and determines values for resource characteristics of the resources 304 that will satisfy the received resource requirements 316. The resources 304 can control one or more operating characteristics 320 using the received resource characteristics 318. The one or more software components 302 may comprise applications, portions of applications, the OS 210 or portions of the OS 210 including drivers 214 for components of the electronic device.

The policy manager 300 comprises an interface 306 for receiving one or more resource requirements 316 from software 302. The policy manager 300 also comprises an interface 308 for providing resource characteristics 318 to resources of the electronic device 304 as determined by the policy manager 300. Drivers 214 of the electronic device may implement the interface 308 in order to allow the component associated with the driver 214 to communicate with the policy manager 300. Although the resources 304 are depicted separately from the software components 302, it is contemplated that a software component 302 that can provide resource requirements 316 may also be a resource 304 capable of receiving resource characteristics 318 determined and provided by the policy manager 300. The policy manager 300 comprises a solver 310 that receives the resource requirements 316 from the software 302 and determines the resource characteristics 318 to provide to associated resources 304 in order to satisfy the received resource requirements 316.

The policy manager 300 includes information on the resources 312 and their resource characteristics that can be controlled. The resource characteristics may specify a value for an operating characteristic of an associated resource. For example, a graphics component may have a resource characteristic that specifies the operating characteristic mode as either 2D or 3D. Similarly, a NIC may have a resource characteristic specifying the possible bandwidth, and a resource characteristic specifying the possible latency. The resource characteristic may also specify information that can be used by a self-managed component in order to determine appropriate operating characteristics itself. For example, a resource characteristic for a processor may indicate that the processor should provide its highest performance. The processor may then control its operating characteristics as required to provide the resource characteristic. The resource information 312 may specify a plurality of predicates that each define a resource characteristic and allowable values. The allowable values may be a range of values or specific values. Furthermore, the resource information 312 may specify a hierarchy of the allowable values, expressing which values encompass other values. For example, in the case of a NIC, a lower value for latency will encompass a higher value, since the lower latency will satisfy the requested minimum performance. Not all values of resource characteristics may encompass other values. For example, if a resource may be on or off, the two values are mutually exclusive, and neither encompasses the other.

The policy manager 300 also comprises information on dependencies 314 between various resource characteristic values. The dependency information 314 specifies a hierarchical dependency between resource characteristic values. Each dependency may specify one or more resource characteristic values that must be provided in order for a target resource requirement 316 to be provided. For example, if a display 112 is required to be on, it will also require display information that is provided by a graphics component 108. As a result, a dependency could specify that if the display 112 is on, the graphics component 108 also needs to be on. The dependency information 314 may be represented as a directed graph. The directed graph of the dependency information should not have any circular dependencies, that is, a resource characteristic value should not require setting a value for the same resource characteristic. As such, the dependency information 314 provides a hierarchical dependency between resource characteristic values. The acyclic nature of the dependency information may be enforced externally to the policy manager, for example when creating the dependency information if it is static. Additionally or alternatively, the policy manager 300 may provide functionality for enforcing the acyclic nature of the dependency information 314 and for allowing the dependency information 314 to be dynamic (e.g. changing from time-to-time).

The solver 310 receives the resource requirements 316 from software 302 through the interface 306. The solver 310 uses the dependency information 314 to determine the required values for resource characteristics of one or more resources 304 in order to satisfy the resource requirements 316. The solver 310 may determine the required values by treating the resource requirement 316 request as a logical predicate that needs to be true. The solver 310 may then use the dependency information 314 to determine one or more resource characteristic values that also need to be true in order to make the original predicate true. Once all of the resource characteristics values of the one or more resources 304 are determined from the dependency information 314, they are provided to the associated resources 304 which use the provided resources characteristics to determine operating characteristics of the resources 304. Any resource characteristics whose values have not been explicitly set, may be set to their lowest value, that is the value that makes the least demand on the associated resource 304. Alternatively, a resource 304 may determine the values of operating characteristics if resource characteristics are not explicitly provided. The resource 304 may, for example use default values for the operating characteristics.

Placing the lowest performance demand on a resource 304 may also inherently be associated with the lowest power consumption; however if this is not the case, the resource information 312 may also include power consumption information associated with each resource characteristic value in order to allow the solver 310 to determine the values for resource characteristics for the resources 304 of the electronic device 100 that will provide the lowest power consumption while still satisfying the received resource requirements 316.

The received resource requirement 316 requests may specify a resource characteristic value explicitly or implicitly. For example, a resource requirement 316 may specify that the graphics component 108 be turned on. Alternatively, the resource requirement 316 may specify a resource characteristic value implicitly. For example, the resource requirement 316 may specify an operating state of a software component 302. The dependency information 314 may in turn specify the resource characteristic values required when the software component 302 is operating in the state indicated by the received resource requirement 316. For example, a web browser may require a display screen to be on when the user is interacting with the browser. A received resource requirement 316 may indicate to the policy manager 300 that the browser is currently operating in a mode that allows user interaction and the dependency information 314 may be used to determine that, for example the display 112 needs to be on.

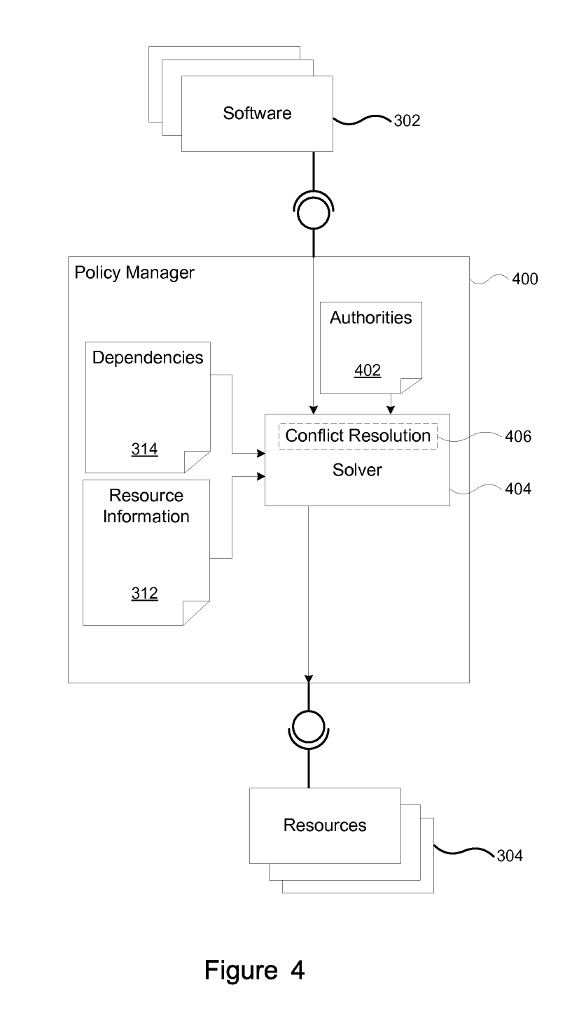

FIG. 4 depicts in a block diagram components of a further example policy manager. The policy manager 400 is similar to the policy manager 300; however, it includes authority information 402. The authority information 402 provides a relative ranking of software components 302 or resource requesters that can provide resource requirement 316 requests to the policy manager 400. The authority information 402 allows the solver 404, or more particularly a conflict resolution component 406 of the solver 404, to resolve conflicts between resource characteristic values required to satisfy received resource requirements 316. For example, one software component 302 may provide a resource requirement 316 that indicates the display should be turned on while another software component 302 may provide a resource requirement 316 that indicates the display should be turned off. Both of these resource requirements 316 cannot be met concurrently. In order to satisfy both resource requirements 316 the conflict resolution component 406 uses the authority information 402 to determine which resource requirement 316, or resource characteristic value, should be met

The authority information 402 may specify the authorities in various ways. For example, the authority information 402 may specify a plurality of relative authorities between resource requesters. The plurality of relative authorities can be assembled into a hierarchical tree structure that can be used when resolving conflicts. A resource requester may be associated with one of the authorities in the hierarchical tree structure. As a result, the resource requirement 316 of the resource requester having the higher authority is used.

Alternatively, an authority may be associated with individual resource requirements 316. The individual resource requirement 316 can be requested by a resource requester by indicating the associated authority. The solver 404, or the conflict resolution component 406 is informed by information regarding the relative ranking of the specified authorities. As such, the conflict resolution component 406 can determine which authority, and so associated resource requirement, is to prevail if conflicts exist.

The solver 404, may be implemented as a state machine. Each time a new, or updated resource request 316 is received, it may be added to a list of current resource requests 316 and the values of resource characteristics to provide to the associated resources 304 of the electronic device may be determined from the dependency information 314 and the resource information 312.

In addition to providing resource characteristics based on received resource requirements 316, the policy manager 400 may inform the software components 302 or the resources 304 of changes to resource characteristic values, which may allow the software components 302 or the resources 304 to modify their resource requirements 316. The software components 302 may register with the policy manager in order to indicate changes they wish to be notified of. As an example provided for clarity of the description, if a browser is operating, it may specify that it needs a display on. The browser may also indicate that an audio component be on in order to playback audio associated with a displayed web page. At some time a screen blanking component that turns off the display when there is no user input after a period of inactivity, provides a resource requirement 316 request indicating that the display should be off. The solver 404, using the authority information 402, may determine that the screen blanking component has a greater authority than the browser and so its resource requirement 316 request takes precedence over the browser's. As such, the solver 404 will modify the resource characteristic value to turn off the display. The solver 404 may communicate to the browser that the display has been turned off. As a result, the browser may switch to a suspended mode, in which there is no need to have the audio component on. The browser may change the resource requirements 316 it provided to the solver 404, which may result in turning off the audio component.

As described above, the policy manager, either 300 or 400, provides a general framework that allows management of resources 304 of the electronic device 100. As a result of managing the resources 304 it is possible to reduce the power consumed by the electronic device 100. The use of the dependency information 314 allows a software component 302 to merely specify the performance it requires from the resources 304, or alternatively an operating mode it is in, making the incorporation of power management into software components 302 much simpler. Furthermore, the dependency information 314 may be used to provide an abstraction between the generalized resources 304 of electronic devices 100 and a particular implementation, allowing the same policy manager 300 or 400 to be used across different devices 100 by modifying the dependency information 314. For example, a software component 302 may specify that it requires a display to be on without requiring any knowledge pertaining to the actual implementation of the display in the specific electronic device 100. The dependency information 314 may provide the required resource characteristic values for a specific implementation of the display on the electronic device 100.

The resource characteristics and associated values may be provided as a string having, for example, a format of <class>/<name>/<mode>/<characteristic>: [value]. It is contemplated that not every resource characteristic needs to specify all of the <class>, <name>, <mode> and <characteristic> however one or more values need to be provided for each resource characteristic. The class may be used to group different types of resource characteristics together. For example, the <class> may specify one of: application, function or device. The application class may be associated with high-level resource characteristics of an application, which may be used to, for example, specify an operating mode of an application. The function class may be used to provide a generalized function of the electronic device, for example a function may be a display. The device class may be used to provide resource characteristics of specific hard components of the electronic device 100. Although a particular specification is provided for the resource characteristics and values, it is contemplated that other ways of expressing the resource characteristics of resources 304 of the electronic device, and the associated allowable values can be used.

A dependency between two resource characteristic values may be expressed as a statement between two or more predicates, where the predicates are the resource characteristics and values. For example, a dependency statement may by: DEPENDENCY function/display/brightness: [1.10] NEEDS device/lcd_display/backlight: LOW, which indicates that in order to have function/display/brightness set between [1 . . . 10] device/lcd_display/backlight must be set to LOW. From the illustrative dependency it is clear that the dependency information 314 specifies the resource characteristic value of one or more resources 304 needed to provide a particular value for a target resource characteristic.

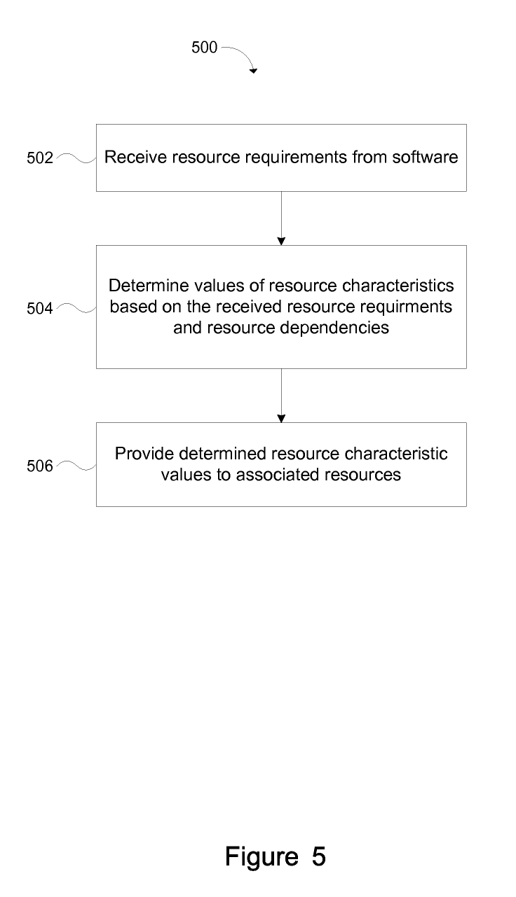

FIG. 5 depicts in a flow chart a method of managing resources on an electronic device. The method 500 receives one or more resource requirements from one or more resource requesters, such as software components (502). The resource requesters making the requests may be software components 302, including for example, applications 218 running on the electronic device 200, an operating system 210 of the electronic device 200 or portions of an application 218 or the OS 210. The resource requirements specify, either directly or indirectly, a value for a resource characteristic required by the resource requester. The method 500 determines values for resource characteristics from the received resource requirements using the dependency information (504). In order to determine the resource characteristic values, the received resource requirements may be considered logical predicates that are required to be true. The dependency information 314 provides the list of other logical predicates, or resource characteristic values, which must be true in order to make the first logical predicate true. The dependency information 314 may be traversed in order to determine all the predicates that need to be true, that is the resource characteristic values, in order to make the received predicates, or the received resource requirements, true. Once all of the performance characteristic values required to provide the received resource requirements are determined, any resource characteristics that do not require a specific value may be set as a lowest value, with regards to performance or power consumption. Once the resource characteristic values are determined, they are provided to the associated resources (506). The policy manager 300 or 400 may provide the resource characteristic values to the associated resources in a specified order, for example, in order to ensure power is provided to a resource 304 before attempting to set another resource characteristic value of the resource 304. Advantageously, as described, the method can manage both externally managed devices that require that values for operating characteristics be provided as well as self managed devices which are provided with resource characteristics, for example specifying a desired level of service that are used by the self-managed device to determine the values for different operating characteristics themselves..

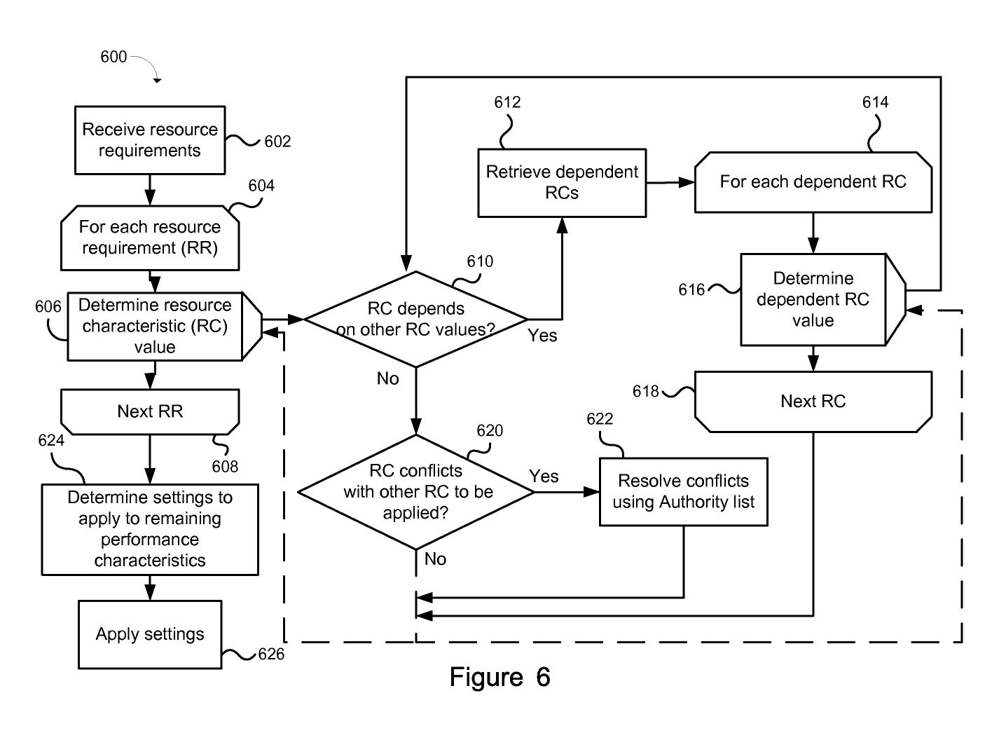

FIG. 6 depicts a further method of managing resources. The method 600 receives the resource requirements (602) and for each resource requirement (604, 608) recursively determines resource characteristic values (606) associated with resources 304 required to provide the resource requirement. For each resource characteristic value required in order to provide the resource requirements, it is determined if the resource characteristic value depends on one or more other resource characteristic values (610). If it does (Yes at 610), the resource characteristic values it depends on are retrieved (612) and for each of the retrieved dependent resource characteristic values (614, 618) the resource characteristic values required for it to be true are recursively determined (616) by returning to 610. If the resource characteristic value does not depend on any other resource characteristics (No at 610) it is determined if the resource characteristic conflicts with any other resource characteristics to be applied (620) and if it does the conflict is resolved using authority information (622) to determine which of the resource requesters of the conflicting performance characteristic values has the higher authority, or alternatively which of the resource requirement requests is associated with the higher authority. If there are no conflicts (No at 620) or if the conflicts have been resolved, processing returns to the previous recursion level, that is 616, or 606. Once all of the required resource characteristics values are determined they are provided to the associated resources (626). The associated resources may use the resource characteristic values in order to set an associated operating characteristic of the device, or may be used by the resource to determine for itself the values for one or more operating characteristics.

Although not described in detail with regards to method 600, the set of resource characteristic values to apply may be tracked throughout the method 600 in various ways. For example, each time a resource characteristic value is to be set, it may be added to a list of current resource characteristic values. The list of current resource characteristic values may be used to determine if there is a conflict by checking the list to see if another value is set that is mutually exclusive with the new value. Additionally, the above has described checking for a conflict only on the lowest level of recursion, namely when the resource characteristic does not depend upon any others; however, it is also possible to determine earlier if the resource characteristic value conflicts with any other current resource characteristic values.

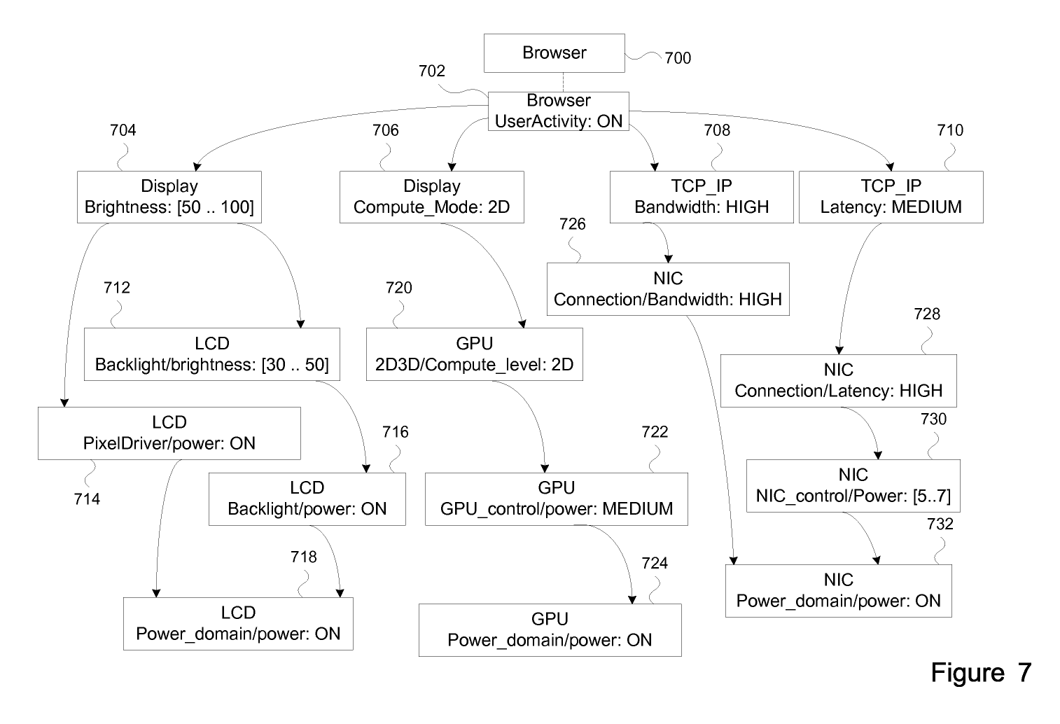

The operation of the policy manager 400, which includes the conflict resolution component 406, is further described by way of an example with reference to FIGS. 7-11. The example describes the policy manager 400 operating on an electronic device to control an LCD display resource that comprises hardware components such as an LCD driver and a backlight, a graphics component that can operate in either a 2D rendering mode or a 3D rendering mode, a NIC that can provide either high, medium or low bandwidth as well as high, medium or low latency, and an audio component that can provide either standard quality audio or high quality audio. The example describes the overall operation of the policy manager 400 when one or more applications are running on the electronic device. The illustrative applications include a browser, an audio playback program, a game and a screen blanking application.

FIG. 7 depicts a dependency requirement for a browser operating in a user_active mode. The browser may have other operating modes, however, only a single mode is depicted in FIG. 7 for clarity of the description.

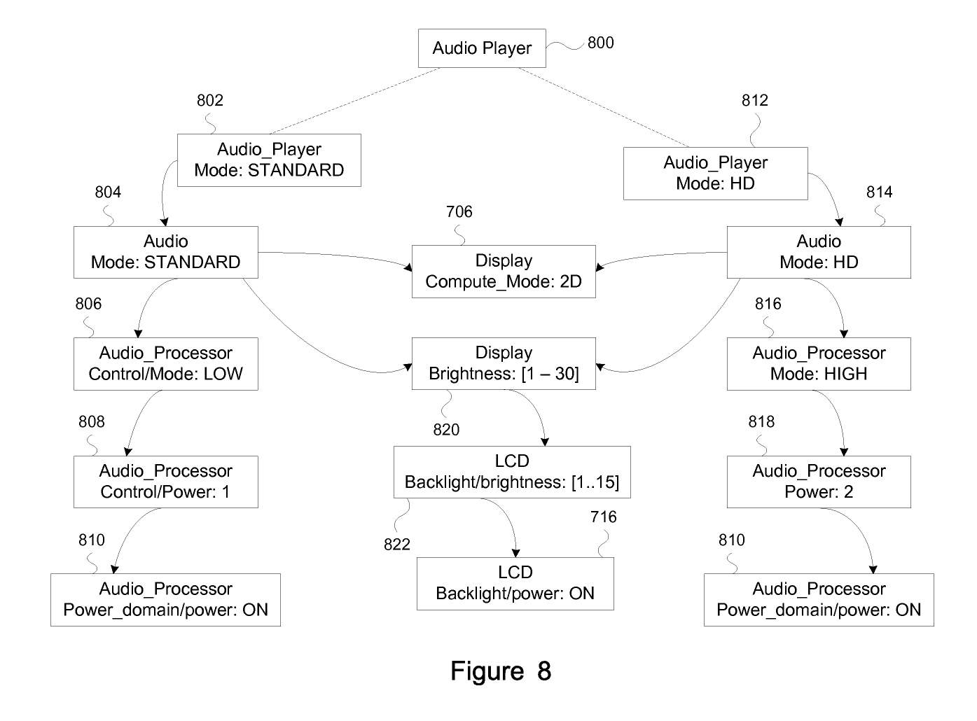

FIG. 8 depicts a dependency requirement for an audio player. Two operating modes are depicted, namely a STANDARD playback mode and an HD playback mode.

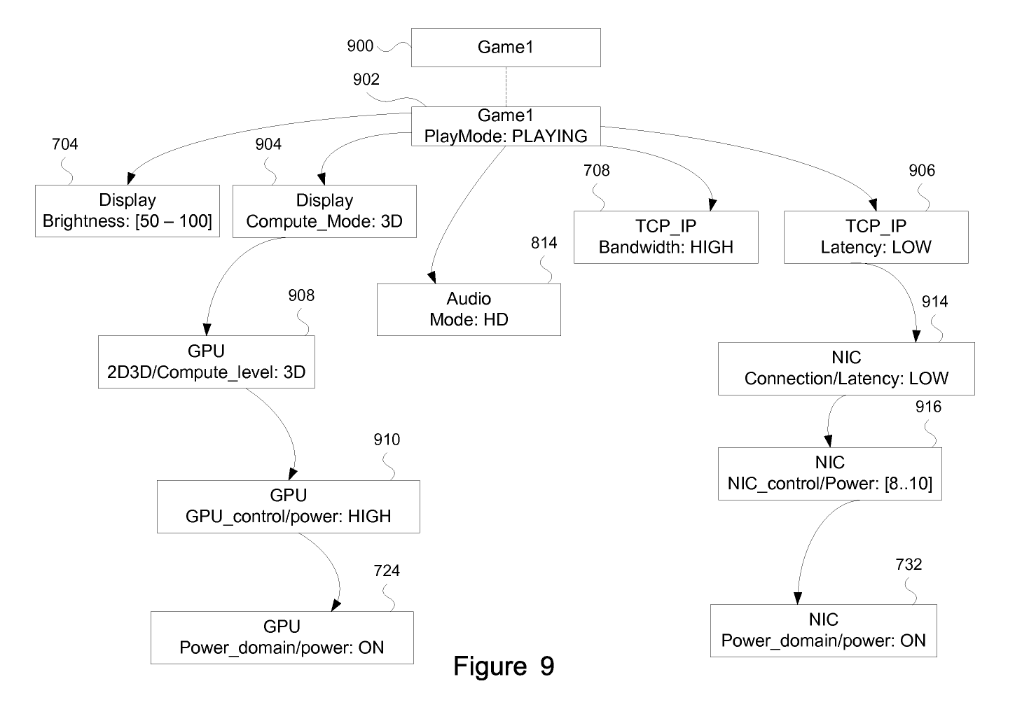

FIG. 9 depicts a dependency requirement for a game operating in a PLAYING playmode. Similar to the browser, only a single operating mode is depicted for the game although other modes may be provided.

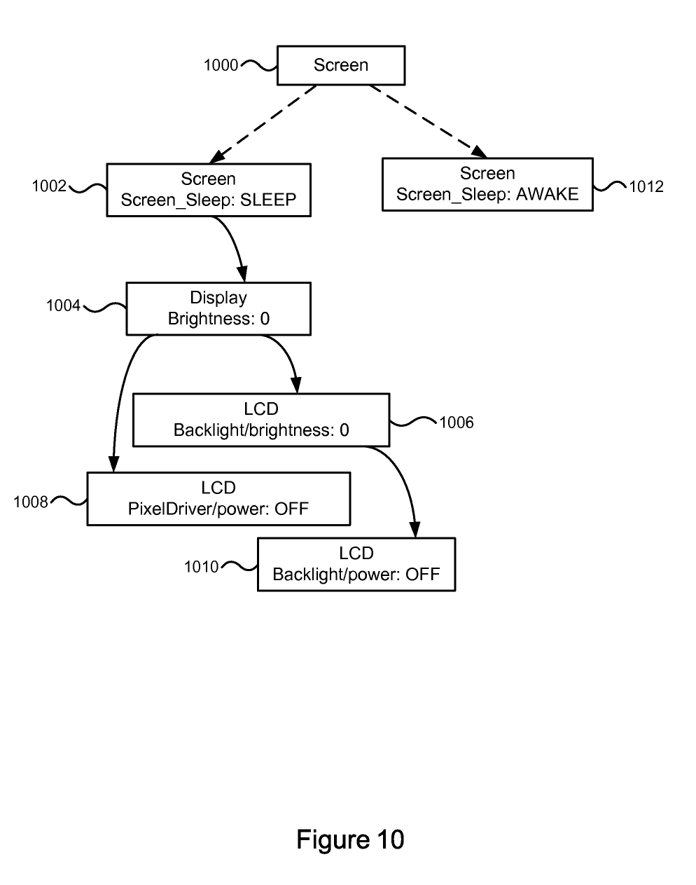

FIG. 10 depicts a dependency requirement for the screen blanking application. Similar to the audio player two operating modes are depicted for the screen blanking application; however, only one, namely the SLEEP mode, has any dependencies.

In the example, a user may operate the browser with no other applications running. The browser 700 informs the policy manager 400 of its resource requirements, which may be done by indicating to the policy manager 400 that the browser 700 is in the UserActivity: ON mode 702. The policy manager 400 receives the new resource requirements and determines the resource characteristic values from the dependency information. As depicted in FIG. 7, when the Browser UserActivity is ON 702, the Display brightness needs to be between 50-100 704, the display compute mode needs to be 2D 706, the TCP_IP bandwidth needs to be HIGH 708 and the TCP_IP Latency needs to be MEDIUM 710. As depicted, each of these resource characteristics in turn depends on other values being set for the resource characteristic values of the resources 304. The complete resource characteristic values of the resources 304 are determined from the dependency information 314 and the resource requirements. When only the browser 700 is running, the resource characteristic values required are:

Function/Display/Brightness: [50-100] 704

Function/Display/Compute_mode: 2D 706

Function/TCP_IP/Bandwidth: HIGH 708

Function/TCP_IP/Latency: MEDIUM 710

Device/LCD/Backlight/Brightness: [30 . . . 50] 712

Device/LCD/PixelDriver/Power: ON 714

Device/LCD/Backlight/Power: ON 716

Device/LCD/Power_domain/Power: ON 718

Device/GPU/2D3D/ComputeLevel: 2D 720

Device/GPU/GPU_control/Power: MEDIUM 722

Device/GPU/Power_domain/Power: ON 724

Device/NIC/Connection/Bandwidth: HIGH 726

Device/NIC/Connection/Latency: HIGH 728

Device/NIC/NIC_control/Power: [5 . . . 7] 730

Device/NIC/Power_domain/Power: ON 732

Once all of the resource characteristic values are determined from the dependency information 314, they are provided to the associated resources. In addition to determining and providing the resource characteristic and values determined from the resource requests and the dependency information, it is further possible to determine resource characteristic values for the remaining resource characteristics of resources not explicitly determined from the resource requirements. The values for the remaining resource characteristics may be set to values that makes the least demand on the associated resource. For example, it is assumed above that the browser 700 does not require any sound, and as such the sound processor may be turned off. Alternatively, the resources themselves may have default operating characteristics to use. Once the resource characteristic values are provided, the resources utilize the information to control one or more operating characteristics, either directly by setting the operating characteristic value based on the resource characteristic value, or indirectly by using the resource characteristic values to determine one or more operating characteristic values.

To continue with the example, while using the browser 700, it is assumed that the user begins to listen to the audio player 800. Initially the audio player 800 is in the STANDARD playback mode 802. The audio player 800 informs the policy manager 400 of the resource requirements by specifying the playback mode. The policy manager 400 adds the resource requirements to the resource requirements of the browser 700 and determines all of the required resource characteristic values. The resource characteristic values required by the browser 700 are as described above. Similarly, the policy manager 400 will determine the resource characteristic values for the STANDARD mode of the audio player 800 as follows:

Function/Audio/Mode: STANDARD 804

Function/Display/Brightness: [1 . . . 30] 820

Function/Display/Compute_mode: 2D 706

Device/LCD/Backlight/Brightness: [1 . . . 15] 822

Device/LCD/PixelDriver/Power: ON 714

Device/LCD/Backlight/Power: ON 716

Device/LCD/Power_domain/Power: ON 718

Device/GPU/2D3D/ComputeLevel: 2D 720

Device/GPU/GPU_control/Power: MEDIUM 722

Device/GPU/Power_domain/Power: ON 724

Device/Audio_Processor/control/Mode: LOW 806

Device/Audio_Processor/control/Power: 1 808

Device/Audio_Processor/Power_domain/Power: ON 810

It is noted that the dependencies of the display compute_mode: 2D 706 and display brightness [50 . . . 100] 704 are not depicted in FIG. 8 for brevity and would be the same as shown in FIG. 7. As can be seen, both the audio player 800 and the browser 700 require the display, however there is no conflict between the two resource requirements. As such, the policy manager 400 is able to provide the determined resource characteristic values to the resources 304.

At a later point in time, the user of the audio player 800 switches to the high definition (HD) mode 812, and the policy manager 400 is informed of a new resource requirement. As a result, the policy manager 400 changes the resource characteristic values, which again have no conflicts, to reflect the new request. In particular, the following resource characteristics are changed to new values:

Function/Audio/Mode: HD 814

Device/Audio_Processor/control/Mode: HIGH 816

Device/Audio_Processor/control/Power: 2 818

Continuing with the example, the user turns off the audio player 800 and begins playing a game 900 while continuing to use the browser 700. The game 900 indicates its resource requirement to the policy manager 400. The PLAYING mode 902 of the game requires that the Display brightness be between 50 and 100 704, the display compute mode be 3D 904, the audio be in the HD mode 814, the TCP_IP provide high bandwidth 708 and low latency 906. Of the performance requests by the browser 700 and the game 900, the display compute mode and the TCP_IP latency requirements are different. However, the 3D compute mode encompasses the 2D compute and so by setting the resource characteristic value to 3D both resource requirements are met. Similarly the TCP_IP latency LOW satisfies the TCP_IP latency HIGH resource characteristic value required by the browser 700. As such, the policy manager 400 determines the set of resource characteristic values to apply as follows:

Function/Display/Brightness: [50-100] 704

Function/Display/Compute_mode: 3D 904

Function/Audio/Mode: HD 814

Function/TCP_IP/Bandwidth: HIGH 708

Function/TCP_IP/Latency: LOW 906

Device/LCD/Backlight/Brightness: [30 . . . 50] 712

Device/LCD/PixelDriver/Power: ON 714

Device/LCD/Backlight/Power: ON 716

Device/LCD/Powerdomain/Power: ON 718

Device/GPU/2D3D/ComputeLevel: 3D 908

Device/GPU/GPU control/Power: HIGH 910

Device/GPU/Power_domain/Power: ON 724

Device/Audio_Processor/control/Mode: HIGH 816

Device/Audio_Processor/control/Power: 2 818

Device/NIC/Connection/Bandwidth: HIGH 726

Device/NIC/Connection/Latency: LOW 914

Device/NIC/NIC_control/Power: [8 . . . 10] 916

Device/NIC/Power_domain/Power: ON 732

Continuing with the example, at some time while playing the game 900 and using the browser 700, the screen blanking application 1000 begins running, initially in the AWAKE mode 1012 which has no further resource characteristic value requirements. At a later time, the screen blanking application 1000 determines it should switch to the SLEEP mode 1002, for example if no user interaction has been received for a minute. The screen blanking application 1000 indicates its resource requirements to the policy manager 400 by indicating that it is in the SLEEP mode 1002. The policy manager 400 determines the resource characteristic values required from the various resource requirements, however, there is now a conflict between the resource requirements of the screen blanking application 1000, the browser 700 and game 900. The screen blanking application 1000 requests to have the display off, indicated by a value of 0 1004, while the browser 700 and the game 900 require the screen to be on, indicated by a value greater than 0. Since the two values for the resource characteristics, required in order to fulfill the resource requirements, are mutually exclusive, the policy manager 400 uses the authority information 402 to resolve the conflict.

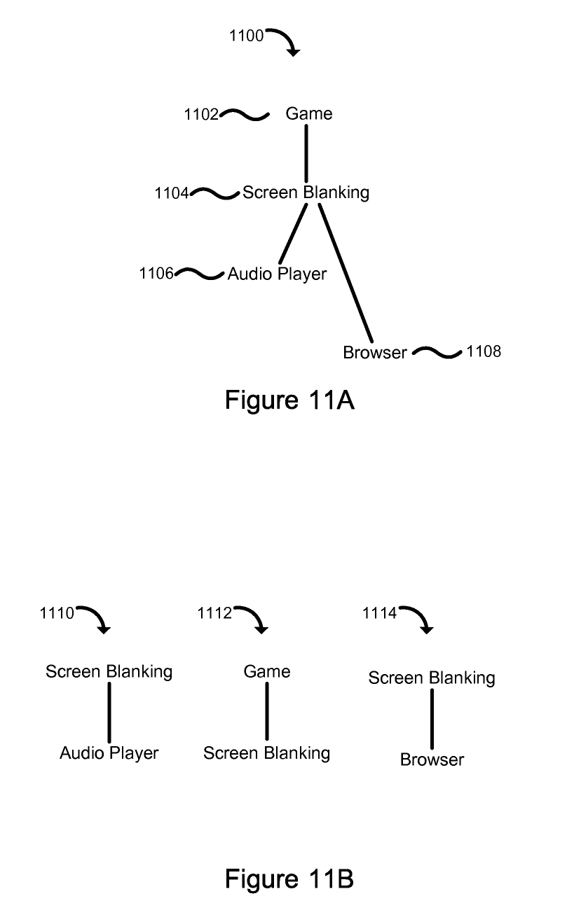

FIG. 11A depicts illustrative authority information associated with the applications of FIGS. 6-10. As depicted by the authority information 1100, the Game 1102 has a higher authority than the Screen 1104, which in turn has a higher authority than both the audio player 1106 and the browser 1108. The authority information may be provided as relative authorities between software components, or resource requestors capable of providing performance requests. As depicted, there is no authority information provided between the audio player 1106 and the browser 1108. The use of a tree structure to represent the authority information, rather than an absolute ranking, allows greater flexibility in assigning authorities. The authority information may be derived from a plurality of relative authorities 1110, 1112, 1114 as depicted in FIG. 11B.

Returning to the example, using the authority information 1100, the policy manager 400 determines that the game 1102 has a higher authority than the screen blanking application 1104 and as such the display remains on, and the resource characteristic values would be determined as described above with regards to only the browser 700 and game 900 running.

Finally, if the user stops the game 900, the game's resource requirements will be removed from the policy manager 400. If the screen blanking application 1000 again provides it's resource requirements to be in the SLEEP mode, there will be a conflict between the screen blanking application 1000 and the browser 700 as described above. However, now the screen blanking application 1000 has the higher authority and as such the display will be turned off 1004, which will require the LCD pixel driver to be off 1008, and the LCD backlight to have a brightness of 0 1006 which in turn requires the power of the backlight to be off 1010. Once the display is turned off, the policy manager 400 may indicate the change to the browser 700, which in response may determine that it does not require any specific resource characteristics with the display off, and so may indicate the changed resource requirements to the policy manager 400, which will subsequently determine the resource characteristic values for the resources 304 and provide them accordingly.

As described above, the policy manager 300 or 400 can manage the characteristics of resources 304 of an electronic device 100. The policy manager 300 or 400 uses dependency information 314 to determine all the resources characteristic values that need to be set at a particular time. The dependency information 314 allows a software component 302 to simply specify it's operating state, or it's resource requirements and the policy manager 300 or 400 determine all of the required resource characteristic values for the specific resources 304 of the electronic device 100. Advantageously, the policy manager 300 or 400 can be used for different actual hardware implementations by simply modifying the dependency information 314. Furthermore, the policy manager 300 or 400 can communicate resource changes to software components 302, which in turn can use the information to possibly change their operating mode and change their performance requests. The policy manager 300 or 400 provides an efficient means of managing the performance and power consumption of the electronic device 100 as well as resolving any conflicts that may arise between differing performance requests.

Although the above discloses example methods, apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

What is claimed is:

1. A method of managing resources of an electronic device comprising:
receiving resource requirements from one or more resource requesters on the electronic device;
determining values for a plurality of resource characteristics associated with resources of the electronic device based on the received resource requirements and dependency information defining hierarchical dependency requirements between defined resource characteristic values; and
providing the determined resource characteristic values for the plurality of resource characteristics to the respective associated resources of the electronic device.

2. The method of claim 1, further comprising:
receiving one or more of the determined resource characteristic values at a self-managed component;
determining from the one or more received resource characteristic values one or more operational characteristic values of the self managed component; and
applying the one or more operational characteristics values to the self-managed component.

3. The method of claim 1, further comprising:
receiving the one or more of the determined resource characteristic values at an externally managed component; and
applying the received one or more resource characteristics values to one or more operational characteristics of the externally managed component.

4. The method of claim 1, wherein determining the resource characteristic values comprises determining the resource characteristic values that satisfies the received resource requirements and provide a lowest power consumption of the associated resources of the electronic device.

5. The method of claim 1, wherein each of the received resource requirements provides a value for a pre-defined resource characteristic having a range of allowable values.

6. The method of claim 1, wherein each dependency specifies one or more dependent resource characteristic values required in order to provide a target resource characteristic value.

7. The method of claim 5, wherein the pre-defined resource characteristics include one or more of:
application resource characteristics for defining resource characteristic values of an application that can be executed on the electronic device;
functional resource characteristics for defining resource characteristic values of functionality provided by the electronic device; and
device resource characteristics for defining resource characteristics values of hardware components of the electronic device.

8. The method of claim 7, wherein the dependency information comprises one or more of:
a dependency requirement between an application resource characteristic value or range of values and a device resource characteristic value or range of values;
a dependency requirement between an application resource characteristic value or range of values and a functional resource characteristic value or range of values; and
a dependency requirement between a functional resource characteristic value or range of values and a device resource characteristic value or range of values.

9. The method of claim 1, further comprising:
associating a respective authority indicator with received resource requirements;
determining that a conflict exists between determined resource characteristic values; and
resolving the conflict using authority information specifying relative authority precedence associated with a plurality of authority indicators, including the respective authority indicator associated with each received resource requirement.

10. The method of claim 1, further comprising:
receiving one or more revised resource requirements;
determining updated resource characteristic values from the revised resource requirements;
providing the updated resource characteristics values to the associated resources; and
notifying one or more of the resource requesters of at least one of the updated resource characteristic values.

11. The method of claim 10, further comprising:
registering one or more resource requesters for notification of a change to one or more resource characteristic values.

12. The method of claim 1, wherein the resource requesters comprise software components executing on the electronic device, and one or more of the resources comprise hardware components of the electronic device, wherein the resource characteristic values are provided to hardware components using an associated device driver.

13. The method of claim 12, wherein resource characteristics and associated resource characteristic values define one or more of modes of functionality or performance levels of the hardware component.

14. An electronic device for managing performance of resources of the electronic device, the electronic device comprising:
a processor for processing instructions;
a storage unit for storing instructions and data, the instructions when executed by the processor configuring the electronic device to provide a policy manager comprising:
an interface for receiving resource requirements from one or more resource requesters executing on the electronic device ;
a solver for determining values for a plurality of resource characteristics associated with resources of the electronic device based on the received resource requirements and dependency information defining hierarchical dependency requirements between defined resource characteristic values; and
a resource interface for providing the determined resource characteristic values to the respective associated resources of the electronic device.

15. The electronic device of claim 14, wherein one or more of the resources of the device comprise:
a self-managed component that receives the one or more resource characteristic values and determines one or more operational characteristics to apply to the self-managed component based on the resource characteristic values.

16. The electronic device of claim 14, wherein one or more of the resources of the device comprise:
an externally-managed component that can apply the one or more resource characteristic values to one or more operational characteristics of the externally managed component.

17. The electronic device of claim 14, wherein the solver determines the resource characteristic values by determining the resource characteristic values that satisfy the received resource requirements and provide a lowest power consumption of the resources of the electronic device.

18. The electronic device of claim 14, further comprising:
resource information defining for each of a plurality of resources of the electronic device a plurality of resource characteristics and respective allowable values; and
the dependency information defining dependency requirements between resource characteristic values.

19. The electronic device of claim 14, wherein the defined resource characteristics include one or more of:
application resource characteristics for defining characteristic values of an application that can be executed on the electronic device;
functional resource characteristics for defining characteristic values of functionality provided by the electronic device; and
device resource characteristics for defining characteristics values of hardware components of the electronic device.

20. The electronic device of claim 19, wherein the dependency information comprises one or more of:
a dependency requirement between an application resource characteristic value or range of values and a device resource characteristic value or range of values;
a dependency requirement between an application resource characteristic value or range of values and a functional resource characteristic value or range of values; and
a dependency requirement between a functional resource characteristic value or range of values and a device resource characteristic value or range of values.

21. The electronic device of claim 14, wherein:
the received resource requirements are associated with a respective authority indicator; and
the solver determines that a conflict exists between determined resource characteristic values, and resolves the conflict using authority information specifying a relative authority between a plurality of authority indicators, including the respective authority indicator associated with each received resource requirement.

22. The electronic device of claim 14, wherein:
the interface for receiving resource requirements is further for receiving an updated resource requirement from one or more of the resource requesters that changes the received resource requirements;
the solver further determines updated values for resource characteristic from a revised resource requirements and notifies one or more resource requesters of at least one of the updated resource characteristic values; and
the resource interface provides the updated resource characteristics values to the associated resources.

23. The electronic device of claim 22, wherein the policy manager registers the one or more resource requesters for notification of a change to one or more resource characteristic values.

24. The electronic device of claim 14, wherein the resource requesters comprise software components executing on the electronic device, and one or more of the resources comprise hardware components of the electronic device, wherein the resource characteristic values are provided to hardware components using an associated device driver.

25. A computer readable memory comprising instructions for execution by a processor, the instructions comprising:
receiving resource requirements from one or more resource requesters on the electronic device;
determining values for a plurality of resource characteristics associated with resources of the electronic device based on the received resource requirements and dependency information defining hierarchical dependency requirements between defined resource characteristic values; and
providing the determined resource characteristic values for the plurality of resource characteristics to the respective associated resources of the electronic device.
